(19) United States
(12) Patent Application Publication
(10) Pub. No.: US 2011/0304798 A1
(43) Pub. Date: Dec. 15, 2011

(54) ILLUMINATION DEVICE AND LIQUID CRYSTAL DISPLAY DEVICE

(75) Inventors: Atsuyuki TANAKA, Osaka-shi (JP); Takeshi MASUDA, Osaka-shi (JP); Shinji SUMINOE, Osaka-shi (JP); Kohji ITOH, Osaka-shi (JP)

(73) Assignee: SHARP KABUSHIKI KAISHA, Osaka (JP)

(21) Appl. No.: 12/797,748

(22) Filed: Jun. 10, 2010

(51) Int. Cl. G02F 1/1335; F21V 1/00

(52) U.S. Cl. 349/64; 362/235

(57) ABSTRACT

An illumination device 10 includes a diffusion plate 13 for diffusing light emitted from light sources 17, which diffusion plate 13 is fixed on first partition walls 11 and provided on upper sides of light source blocks 18. The arrangement makes it possible to provide a high-quality illumination device and a high-quality liquid crystal display device in each of which unevenness in luminance and color is restrained so that a luminance distribution becomes constant.

This Nonprovisional application hereby incorporate by reference the entire contents of Patent Application No. 2007-315191 filed in Japan on Dec. 5, 2007.

### TECHNICAL FIELD

The present invention relates to a backlight including a plurality of light sources and a liquid crystal display device including the backlight.

### BACKGROUND ART

Liquid crystal display devices have such features that they are reduced in thickness, their power consumption is low, and they have a high resolution. Further, along with an increase in screen size of these liquid crystal display devices due to development of manufacturing techniques, the liquid crystal display devices have become widely used in a television field that used to employ cold-cathode tubes (CRT) mainly. However, there is a problem that an image displayed by such a liquid crystal display device has low contrast (dynamic range) due to a display method of the liquid crystal display device, in comparison with an image displayed by the CRT. On this account, there have been vigorously developed techniques for improving image quality, in recent years.

For example, Patent Literature 1 discloses a liquid crystal display device in which a plurality of illumination regions are provided so that luminance of a backlight can be controlled independently per illumination region. That is, the liquid crystal display device disclosed in Patent literature 1 virtually has a plurality of display regions corresponding to the plurality of illumination regions in the backlight. The liquid crystal display device controls luminance of irradiating light of each of the illumination regions in the backlight, in accordance with brightness of an image to be displayed on a corresponding display region in the liquid crystal display device. That is, according to Patent Literature 1, in an illumination region corresponding to a display region on which a bright image is to be displayed, luminance of irradiating light is controlled to be high. On the other hand, in an illumination region corresponding to a display region on which a dark image is to be displayed, luminance of irradiating light is controlled to be low. This allows increasing in a dynamic range, thereby realizing a liquid crystal display device that can display an image with high contrast.

The technique disclosed in Patent Literature 1 suggests, as a backlight including a plurality of illumination regions, a direct-illumination-type backlight 100 in which a plurality of light sources 101 are separated from each other per illumination region by partition walls 102, as illustrated in FIG. 8.

FIG. 8 is a view illustrating an arrangement of a backlight section disclosed in Patent Literature 1. The light source 101 illustrated in FIG. 8 is a cold-cathode fluorescent tube, and a white LED (not shown) for luminance adjustment is provided below the light source 101. It is disclosed in Patent Literature 1 that the LED allows for increasing a luminance ratio, i.e., a dynamic range, of irradiating light between adjacent illumination regions.

Further, Patent Literature 1 discloses that by separating the illumination regions from each other by the partition walls 102, it is possible to restrain mutual interference of irradiating light that occurs between the adjacent illumination regions, thereby making it possible to obtain an image with higher quality. However, the above arrangement causes such a problem that the irradiating light is blocked by the partition wall 102 provided between the adjacent illumination regions and therefore a vicinity of an area above the partition wall 102 becomes dark.

In view of this, Patent Literature 2 discloses a color display device.

FIG. 9 is a cross-sectional view illustrating an arrangement of the color display device disclosed in Patent Literature 2.

As illustrated in FIG. 9, the color display device disclosed in Patent Literature 2 is arranged such that LED blocks 113A, 113B, and 113C each including a plurality of LEDs having different wavelengths are provided on a substrate 112. Further, a diffusion sheet 115 is provided so as to face the LED blocks 113A, 113B, and 113C. The diffusion sheet 115 is provided on the substrate 112 in such a manner that the diffusion sheet 115 is supported by second walls 114b. Further, third walls 114e are provided between the LED blocks 113A and 113B and between the LED blocks 113B and 113C. It is disclosed in Patent Literature 2 that a height h of the third wall 114e is set lower than a height H of the second wall 114b. In this arrangement, pieces of light do not cross each other between the LED blocks 113A and 113B and between the LED blocks 113B and 113C. This can prevent that, a vicinity of an area, in the diffusion sheet 115, that is above a partition section of the third wall 114e becomes dark. Consequently, it is possible to prevent luminance unevenness.

### Citation List

Patent Literature 1

Japanese Patent Application Publication, Tokukai, No. 2002-99250

Patent Literature 2

Japanese Patent Application Publication, Tokukaihei, No. 10-39300

### SUMMARY OF INVENTION

### Technical Problem

However, the color display device of Patent Literature 2 has the following problem.

For example, in a case where the LED block 113A is turned on while the LED block 113B, which is an LED block adjacent to the LED block 113A, is turned off, colored silhouette (unevenness in color) occurs in the vicinity of a region, in the diffusion sheet 115, that faces the third wall 114e. This is because the plurality of LEDs having different wavelengths are provided in the LED block 113A, thereby causing color separation in the LED block 113A.

The present invention is accomplished in view of the above problems. An object of the present invention is to provide a high-quality illumination device and a high-quality liquid crystal display device each of which restrains luminance unevenness and color unevenness so that a luminance distribution is constant.

### Solution to Problem

In order to achieve the above object, an illumination device according to the present invention is an illumination device capable of adjusting luminance per light-emitting region and includes: first partition walls by which a plurality of light-emitting regions are separated; light sources each for emitting light having different wavelengths, the light sources being provided in a respective of the plurality of light-emitting regions; second partition walls which are provided higher than the first partition walls and which enclose the plurality of light-emitting regions; optical means for diffusing the light emitted from each of the light sources, the optical means being supported by the second partition walls; and a diffusion section for diffusing the light emitted from the each of the light sources, the diffusion section being fixed on the first partition walls so as to be disposed on upper sides of the plurality of light-emitting regions.

In the above arrangement, when the light sources provided in the respective of the plurality of light-emitting regions are turned on, the optical means emits light.

In this arrangement, the second partition walls are provided higher than the first partition walls. Further, the optical means is supported by the second partition walls while the diffusion section is supported by the first partition walls.

That is, a space is provided between the diffusion section and the optical means. In a case where any adjacent light-emitting regions among the plurality of light-emitting regions are turned on, respective pieces of light emitted from the adjacent light-emitting regions cross each other in the space so as to form mixed light. The mixed light is then diffused by the optical means and emitted from the optical means. Consequently, the above arrangement can prevent that a vicinity of a region in the optical means which region faces the first partition walls becomes dark. This results in that it is possible to restrain an occurrence of luminance unevenness in a case where the light-emitting regions adjacent to each other are both turned on, thereby allowing for obtaining uniform irradiating light.

Further, in the arrangement, the luminance can be adjusted per light-emitting region. In a case where one of the adjacent light-emitting regions is turned on while the other one of the adjacent light-emitting regions is turned off, light emitted from a light source of the one of the adjacent light-emitting regions that is turned on is separated into colors when the light reaches the top portion of the first partition wall. This is because the light emitted from the light source includes pieces of light having different wavelengths. If no diffusion section is provided on the upper sides of the light-emitting regions, the light thus separated into colors is directly irradiated to a corresponding area in the optical means. This results in that the light is observed as color unevenness.

In contrast, in the above arrangement of the present invention, the diffusion section for diffusing light emitted from the light source is provided such that the diffusion plate is provided on the upper sides of the light-emitting regions by being fixed on the first partition walls. When the light having different wavelengths is emitted from the light source, the light passes through the diffusion section and thereby is diffused. In other words, when the light emitted from the light source reaches the top portion of the first partition wall, the light is separated into colors because there is a space between the top portion of the first partition wall and the optical means. However, since the light passes through the diffusion section, the light is diffused, thereby causing the color separation to be obscured. This makes it possible to restrain an occurrence of colored silhouettes, i.e., color unevenness, thereby resulting in that the color unevenness can be hardly observed.

Further, in the above arrangement, the diffusion section is fixed to the first partition walls. If the diffusion section is not fixed to the first partition walls, there may occur such a problem that the illumination device cannot be set upright.

Further, in the case where the diffusion section is not fixed to the first partition walls, even if the diffusion section is fixed to the second partition walls somehow, there may occur such a problem that the diffusion section bends or warps. The bending or warping of the diffusion section causes unevenness in flatness of the diffusion section. As a result, a luminance distribution (spread of luminance) may vary between a case where a certain light-emitting region is turned on and a case where another light-emitting region is turned on.

On the other hand, when the diffusion plate is fixed to the first partition walls as in the above arrangement, it is possible to set the illumination device upright. Further, in this case, the in-plane flatness of the diffusion plate is kept even.

This prevents the diffusion plate from bending, warping, or the like. Consequently, it is possible to prevent such a problem that the luminance distribution varies between a case where a certain light-emitting region is turned on and a case where another light-emitting region is turned on.

In this way, the above arrangement of the present invention restrains luminance unevenness and color unevenness so that a luminance distribution becomes constant, thereby resulting in that it is possible to provide a high-quality illumination device.

It is preferable that the illumination device according to the present invention further include fixing members for fixing the diffusion section to the first partition walls, each of the fixing members including a support section for supporting the optical means.

With the arrangement, a distance between the diffusion section and the optical means is kept constant. The arrangement makes it possible to prevent the occurrence of luminance unevenness due to the first partition walls. Further, the arrangement makes it possible to prevent the bending or warping of the optical means. On this account, in a case where any of the plurality of light-emitting regions is caused to emit light, an obtained luminance distribution is uniform regardless of which light-emitting region is turned on. As such, the above arrangement of the present invention restrains the occurrence of luminance unevenness, thereby resulting in that it is possible to provide an illumination device having a constant luminance distribution.

In the illumination device according to the present invention, it is preferable that (a) each of the first partition walls have a bottom surface whose length in a width direction is longer than that of a top surface of the each of the first partition walls, where (i) the top surface is a surface, of the each of the first partition walls, that has contact with the diffusion section, (ii) the bottom surface is another surface, of the each of the first partition walls, that has contact with a plane on which the light sources are provided, and (iii) the width direction is a direction that defines a thickness of the each of the first partition walls, and (b) the each of the first partition walls have a side surface with respect to the top surface which side surface is formed at least partially in a recessed curved-surface shape.

With the above arrangement, since the side surface of the first partition wall has a recessed curved-surface shape, it is possible that light emitted from the light source can reflect off the side surface upwards with high efficiency. That is, the provision of the first partition walls arranged as such can further retrain a decrease in luminance. Therefore, it is possible to further restrain the decrease in luminance as compared with a case where the side surface does not have the recessed curve-surface shape. As a result, with the above arrangement, it is possible to provide an illumination device that can emit light efficiently.

In the illumination device according to the present invention, it is preferable that the recessed curved-surface shape be formed such that a part of the side surface of the each of the first side walls draws a part of an ellipse, in a cross-sectional plane of the each of the first side walls which plane cuts across along a direction vertical to an extending direction of the each of the first partition walls.

In the arrangement, the curved-surface shape is formed so as to be partially cut out of the ellipse, in its cross-sectional plane cutting across along the direction vertical to the extending direction of the each of the first partition walls. Accordingly, light emitted from the light source can be efficiently reflected toward a substantially vertical direction with respect to a plane on which the light source is provided. That is, with the above arrangement, it is possible to provide an illumination device that can emit light efficiently.

In the illumination device according to the present invention, it is preferable that the recessed curved-surface shape be formed such that a part of the side surface of the each of the first side walls draws a part of a parabola, in a cross-sectional plane of the each of the first side walls which plane cuts across along a direction vertical to an extending direction of the each of the first partition walls.

In the arrangement, the curved-surface shape is formed so as to be partially cut out of the parabola, in its cross-sectional plane cutting across along the direction vertical to the extending direction of the each of the first partition walls. Accordingly, light emitted from the light source can be more efficiently reflected toward a substantially vertical direction with respect to a plane on which the light source is provided. That is, with the above arrangement, it is possible to provide an illumination device that can emit light efficiently.

In the illumination device according to the present invention, it is preferable that each of the second partition walls have a surface which faces a corresponding first partition wall and which at least partially has a recessed curved-surface shape so as to form a pair with a curved-surface shape of the corresponding first partition wall.

With the above arrangement, light emitted from the light source is reflected toward a direction in which the diffusion section is provided, due to the recessed curved-surface shape of the second partition wall. That is, even in a light-emitting region that is surrounded by the second partition wall, it is possible to efficiently reflect light emitted from a light source of the light-emitting region, toward the direction of the diffusion section. As a result, it is possible to provide an illumination device that can emit light efficiently.

In the illumination device according to the present invention, it is preferable that each of the light sources be an LED element. With the arrangement, it is possible to provide a high-quality illumination device having a wide color-reproduction range.

Further, in the illumination device according to the present invention, it is preferable that a circuit component for driving a corresponding light source be provided inside a corresponding first partition wall.

Here, the first partition wall is arranged such that the length, in the width direction, of the bottom surface thereof is longer than that of the top surface thereof. Therefore, it is possible to make room for the circuit component inside the first partition wall. When the circuit component for driving the light source is provided inside the first partition wall as in the above arrangement, an other component can be disposed in a place in which to conventionally dispose the circuit component. As a result, in a case where a heat-releasing rubber or the like is provided in that place, for example, it is possible to provide an illumination device having a high heat-releasing property.

A liquid crystal display device according to the present invention preferably includes any of the illumination devices described above and a liquid crystal panel.

This arrangement restrains luminance unevenness and color unevenness so that a luminance distribution becomes constant, thereby resulting in that it is possible to provide a high-quality illumination device.

### Advantageous Effects of Invention

As described above, in order to achieve the above object, an illumination device of the present invention is an illumination device capable of adjusting luminance per light-emitting region and includes: first partition walls by which a plurality of light-emitting regions are separated; light sources each for emitting light having different wavelengths, the light sources being provided in a respective of the plurality of light-emitting regions; second partition walls which are provided higher than the first partition walls and which enclose the plurality of light-emitting regions; optical means for diffusing the light emitted from each of the light sources, the optical means being supported by the second partition walls; and a diffusion section for diffusing the light emitted from the each of the light sources, the diffusion section being fixed on the first partition walls so as to be disposed on upper sides of the plurality of light-emitting regions.

This arrangement restrains luminance unevenness and color unevenness so that a luminance distribution becomes constant, thereby resulting in that it is possible to provide a high-quality illumination device.

### BRIEF DESCRIPTION OF DRAWINGS

FIG. 1(a) is a plane view illustrating an illumination device according to one embodiment of the present invention.

FIG. 1(b) is a cross-sectional view taken along line A-A′ in FIG. 1(a).

FIG. 2(a) is a plane view illustrating an illumination device according to one embodiment of the present invention.

FIG. 2(b) is a cross-sectional view taken along line B-B′ in FIG. 2(a).

FIG. 3(a) is a plane view illustrating an illumination device according to one embodiment of the present invention.

FIG. 3(b) is a cross-sectional view taken along line C-C′ in FIG. 3(a).

FIG. 4(a) is a cross-sectional view schematically illustrating an arrangement of an illumination device of a modified example of one embodiment of the present invention.

FIG. 4(b) is a plane view illustrating an arrangement of a light source block of the illumination device in FIG. 4(a).

FIG. 5(a) is a cross-sectional view schematically illustrating an arrangement of an illumination device of a second modified example of one embodiment of the present invention.

FIG. 5(b) is a plane view illustrating an arrangement of a light source block of the illumination device in FIG. 5(a).

FIG. 6(a) is a cross-sectional view schematically illustrating an arrangement of an illumination device of a third modified example of one embodiment of the present invention.

FIG. 6(b) is a plane view illustrating an arrangement of a light source block of the illumination device in FIG. 6(a).

FIG. 7 is a cross-sectional view schematically illustrating an arrangement of an illumination device of a fourth modified example of one embodiment of the present invention.

FIG. 8 is a view illustrating an arrangement of a backlight section according to a conventional technique.

FIG. 9 is a cross-sectional view illustrating an arrangement of a color display device according to a conventional technique.

### REFERENCE SIGNS LIST

10, 20, 30, 40, 50, 60, 70 Illumination Device
11, 21, 31, 41, 51 First Partition Wall
12, 22, 32 Second Partition Wall
13, 23, 33 Diffusion Plate (Diffusion Section)
14, 24, 34 Optical Section (Optical Means)
15, 25, 35 Reflecting Plate
16, 26, 36 Fixing Pin (Fixing Member)
17, 27, 37 Light Source
18, 28, 38, 48, 58, 68 Light Source Block (Light-emitting Region)
Liquid Crystal Panel
26a Support Section
31a, 41a, 51a Side Surface
67 LED
78 Driver

### DESCRIPTION OF EMBODIMENTS

### Embodiment 1

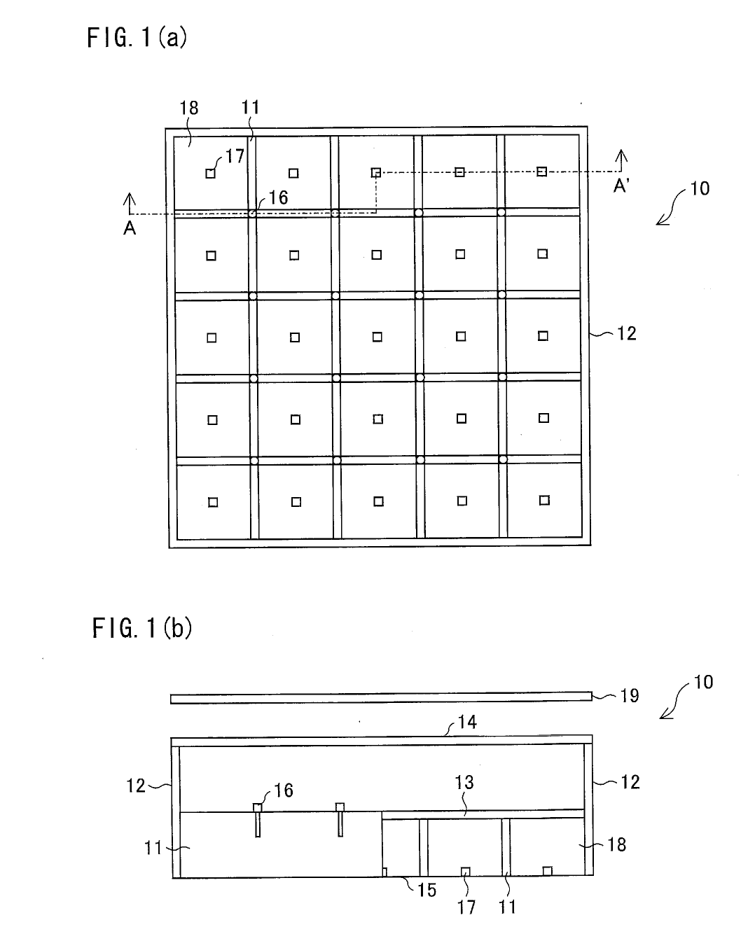

One embodiment of the present invention is described below with reference to FIG. 1(a) and FIG. 1(b).

FIG. 1(a) is a plane view illustrating an illumination device 10 according to one embodiment of the present invention. Further, FIG. 1(b) is a cross-sectional view taken along line A-A′ of FIG. 1(a).

As illustrated in FIG. 1(a), the illumination device 10 includes: first partition walls 11 for dividing the illumination device 10 into a plurality of light source blocks (light-emitting regions) 18; and second partition walls 12 surrounding the illumination device 10 so as to enclose the plurality of light source blocks 18. The first partition walls 11 are disposed in a lattice manner over the illumination device 10. In the present embodiment, a pitch of the light source block 18 (i.e., a length of a side of one cell in the lattice) is 28 mm.

In each of the light source blocks 18 is provided a light source 17 that emits light having different wavelengths. The light source blocks 18 are individually controlled to switch between on (turn-on) and off (turn-off). Further, the light source 17 is constituted by a plurality of light sources each emitting monochromatic light (red light, blue light, green light, or the like light). Alternatively, the light source 17 may be constituted by simply a light source that emits white light. As the light source 17, an after-mentioned LED (Light Emitting Diode) can be used, for example.

On surfaces of top portions of the first partition walls 11 are provided a plurality of fixing pins (fixing members) 16, which are described later. In the present embodiment, each of the fixing pins 16 is provided at an intersection where any two of the first partition walls 11 intersect each other substantially at right angle. However, the fixing pin 16 may be provided at a position other than the intersection of the first partition walls 11.

The top portion of the first partition wall 11 indicates a surface of the first partition wall 11 which surface is opposite to another surface of the first partition wall 11 which surface has contact with a bottom surface of the illumination device 10.

As illustrated in FIG. 1(b), in the illumination device 10, a reflecting plate 15 for reflecting light is provided on a bottom surface of the illumination device 10. The second partition walls 12 are higher than the first partition walls 11 so as to support an optical section (optical means) 14 for diffusing light emitted from the light sources 17. Furthermore, a diffusion plate 13 is provided on upper sides of the light source blocks 18 such that the diffusion plate 13 is disposed between the light sources 17 and the optical section 14 by being supported by the first partition walls 11. The diffusion plate 13 diffuses respective pieces of light emitted from the light source blocks 18. As illustrated in FIG. 1(b), a liquid crystal panel 19, which is described later, is disposed so as to be adjacent to the illumination device 10.

The optical section 14 includes a diffusion plate and a lens sheet, which are described below. When the optical section 14 receives light diffused by the diffusion plate 13, the optical section 14 further diffuses the received light by its diffusing function so as to emit the received light outside the illumination device 10. This allows the illumination device 10 to serve as a plane light source that can emit light with uniform light intensity. Furthermore, the optical section 14 has a function of the lens sheet and therefore can emit light with higher light intensity toward a vertical direction with respect to the optical section 14. Accordingly, it is possible to improve luminance as compared with a case where no lens sheet is provided.

Further, in the top portion of the first partition wall 11, which is a surface of the first partition wall 11 that has contact with the diffusion plate 13, are provided a plurality of holes (recess sections). Further, in the diffusion plate 13, a through hole is provided in a position corresponding to each of the plurality of holes that are provided in the top portion in the first partition wall 11. A fixing pin 16 is inserted into each of the holes in the first partition wall 11 and its corresponding hole provided in the diffusion plate 13. Thus, the fixing pins 16 fix the diffusion plate 13 onto the first partition walls 11.

In the present embodiment, white polycarbonate resin (hereinafter, just referred to as PC) is used as a material of the first partition walls 11 and the second partition walls 12. However, the material thereof is not limited to this, and other materials can be also used provided that they have good reflectance.

As the diffusion plate 13, PC-9391 (65HLW) (product name; made by Teijin Kasei Ltd.) is used, for example. The PC-9391 has such conditions that a thickness is 1.5 [mm], a haze value is 99.2%, total light transmittance is 66.0 [%], and diffused-light transmittance is 65.5 [%]. The reason why the diffusion plate 13 has such a thick thickness is to prevent the diffusion plate 13 from bending, warping, or the like.

The optical section 14 includes a diffusion plate as a lower layer and a lens sheet as an upper layer provided on the diffusion plate. As the diffusion plate in the optical section 14, PC-9391 (65HLW) (product name; made by Teijin Kasei Ltd.) can be used, for example. The PC-9391 used here has such conditions that a thickness is 3.0 [mm], total light transmittance is 66.0 [%], and diffused-light transmittance is 65.5 [%]. Further, as the lens sheet of the optical section 14, lens sheets (RBEF and DBEF) made by 3M Company can be used. As described above, it is preferable that the lens sheet be provided in the optical section 14, but the lens sheet may not be provided.

In the present embodiment, white PC is used for the fixing pins 16. With the use of a white material as the fixing pins 16, it is possible to arrange the fixing pins 16 so as to have good reflectance with respect to light emitted from the light source 17. Further, with the use of PC, it is possible to surely fix the diffusion plate 13 to the first partition walls 11. The fixing pins 16 are used mainly for the purpose of surely fixing the diffusion plate 13 to the first partition walls 11. On this account, the material of the fixing pins 16 is not limited to the white PC, but may be a transparent material, or the like material.

The second partition walls 12 are provided so that they are relatively higher than the first partition walls 11. In the present embodiment, the first partition wall 11 has a height of 10 mm and the second partition wall 12 has a height of 25 mm. By forming the second partition wall 12 to be higher than the first partition wall 11 as such, a space is formed between the diffusion plate 13 and the optical section 14.

In this arrangement, in a case where light source blocks 18 adjacent to each other are both turned on, respective pieces of light emitted from these adjacent light source blocks 18 cross each other in the space so as to form mixed light. Then, the mixed light thus formed in the space is emitted through the optical section 14. This makes it possible to prevent that a vicinity of a region in the optical section 14 which region faces the first partition wall 11 becomes dark. This results in that it is possible to restrain an occurrence of luminance unevenness in the case where the adjacent light source blocks 18 are both turned on, thereby allowing for obtaining uniform irradiating light.

Further, in the illumination device 10 in the present embodiment, the diffusion plate 13 is provided on upper sides of the light source blocks 18 in such a manner that the diffusion plate 13 is supported by the first partition walls 11, so that light passing through the diffusion plate 13 is diffused. Accordingly, in comparison with a case where no diffusion plate 13 is provided on the upper sides of the light source blocks 18, respective pieces of light emitted from the adjacent light source blocks 18 more actively cross each other in the space between the diffusion plate 13 and the optical section 14. This allows for surely restraining luminance unevenness of light irradiated to the optical section 14, thereby resulting in that luminance unevenness in the vicinity of the region in the optical section 14 which region faces the first partition wall 11 can be hardly observed.

Further, assume that one of the adjacent light source blocks 18 is turned on and the other one is turned off. When light emitted from a light source 17 in the one of the adjacent light source blocks 18 reaches the top portion of the first partition wall 11, the light is separated into colors. This is because the light includes pieces of light having different wavelengths. If no diffusion plate 13 is provided on the upper sides of the light source blocks 18, the light thus separated into colors is directly irradiated to the vicinity of the region in the optical section 14 which region faces the first partition wall 11. In this case, the light is observed as color unevenness.

On the other hand, in the illumination device 10 of the present embodiment, the diffusion plate 13 is provided on the upper sides of the light source blocks 18 in such a manner that the diffusion plate 13 is supported by the first partition walls 11. When light having different wavelengths is emitted from the light source 17, the light passes through the diffusion plate 13 and thereby is diffused. In other words, when the light from the light source 17 reaches the top portion of the first partition wall 11, the light is separated into colors. However, in the present embodiment, since the light passes through the diffusion plate 13, the light is diffused, thereby causing the color separation in the light to be obscured. As a result, the arrangement in the present embodiment in which the diffusion plate 13 is provided in such a manner that the diffusion plate 13 is supported by the first partition walls 11 so as to face the light sources 17 can restrain an occurrence of colored silhouettes, i.e., color unevenness, thereby resulting in that the color unevenness can be hardly observed.

Further, as have been already described, each of the fixing pins 16 is inserted into each hole provided in the first partition walls 11 and its corresponding hole provided in the diffusion plate 13. As a result, the diffusion plate 13 is fixed to the first partition walls 11.

More specifically, the hole into which the fixing pin 16 is inserted is provided, for example, in a column shape on a surface of the top portion of the first partition wall 11 which surface has contact with the diffusion plate 13. Similarly, a portion of the diffusion plate 13 that corresponds to the hole provided on the top portion of the first partition wall 11 is processed so that a circular hole is formed. Then, the fixing pin 16 is inserted into the hole on the top portion of the first partition wall 11 and the corresponding hole in the diffusion plate 13. As such, a plurality of holes are provided on the top portions of the first partition walls 11, and a plurality of holes are provided on the diffusion plate 13 in a corresponding manner. The fixing pins 16 are then inserted into a respective of the plurality of holes on the top portions of the first partition walls 11 and a respective of the plurality of holes on the diffusion plate 13 in a corresponding manner, thereby fixing the diffusion plate 13 to the first partition walls 11.

Unlike the present embodiment, in a case where no fixing pin 16 is provided, i.e., the diffusion plate 13 is not fixed to the first partition walls 11, there occurs such a problem that the illumination device 10 cannot be set upright.

More specifically, even in a case where the diffusion plate 13 is fixed to the second partition walls 12 somehow, if the diffusion plate 13 is not fixed to the first partition walls 11, the diffusion plate 13 may bend or warp. The bending or warping of the diffusion plate 13 causes unevenness in flatness of the diffusion plate 13. As a result, a luminance distribution (spread of luminance) varies between a case where a certain light source block 18 is turned on and a case where another light source block 18 is turned on.

On the other hand, when the diffusion plate 13 is fixed to the first partition walls 11 by use of the fixing pins 16 as in the illumination device 10 of the present embodiment, it is possible to set the illumination device 10 upright. Further, in this case, the in-plane flatness of the diffusion plate 13 is kept even. This prevents the diffusion plate 13 from bending, warping or the like. Consequently, it is possible to prevent such a problem that the luminance distribution varies between a case where a certain light source block 18 is turned on and a case where another light source block 18 is turned on.

In the present embodiment, the fixing pin 16 is used as fixing means for fixing the diffusion plate 13 to the first partition walls 11. However, the fixing means is not limited to the fixing pin 16, and an adhesive agent, for example, may be used for fixing the diffusion plate 13 to the first partition walls 11.

In this way, according to the illumination device 10 of the present embodiment, it is possible to reduce color unevenness of light irradiated to the optical section 14 so that the color unevenness is hardly observed even in a case where one of adjacent light source blocks 18 is turned on while the other one of the adjacent light source blocks 18 is turned off. Further, since the flatness of the diffusion plate 13 is uniform, the luminance distribution is constant regardless of which light source block 18 is turned on. As a result, in a case where the luminance is controlled per light source block 18, it is possible to provide a high-quality illumination device 10.

Further, the illumination device 10 of the present embodiment can be used as a backlight of a liquid crystal display device. As described above, the liquid crystal panel 19 is disposed so as to be adjacent to the illumination device 10. The arrangement allows the liquid crystal panel 19 to be irradiated by respective pieces of light emitted from the light source blocks 18 in the illumination device 10. As a result, it is possible to arrange (a) a high-contrast and high-quality backlight system and (b) a high-contrast and high-quality liquid crystal display device, in each of which luminance unevenness and color unevenness are hardly observed and a luminance distribution is constant.

### Embodiment 2

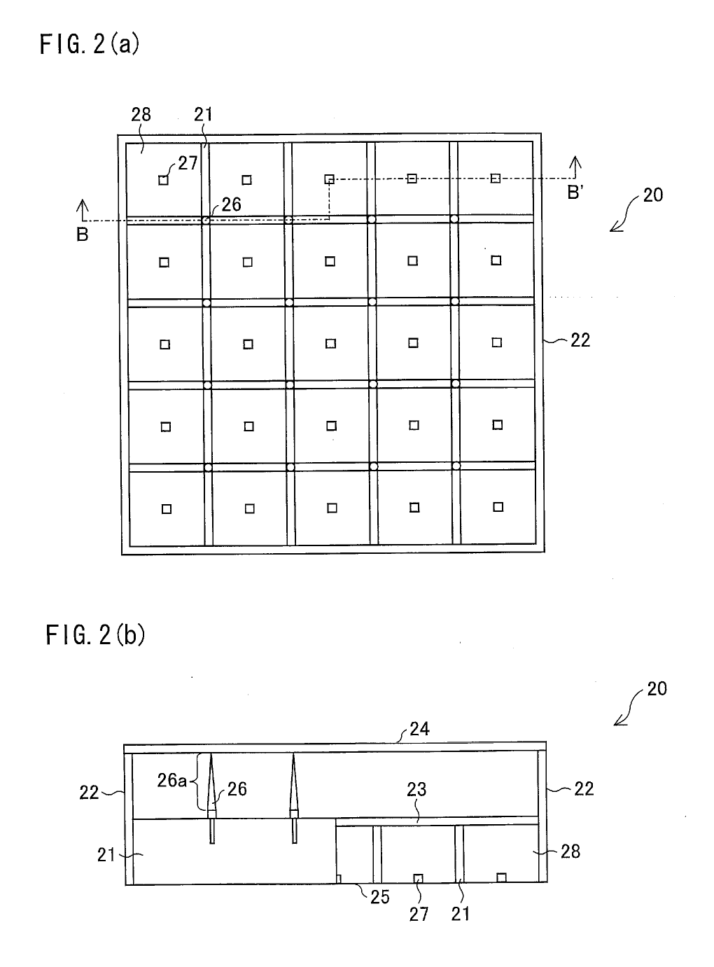

The following describes an illumination device 20 according to the present embodiment with reference to FIG. 2(a) and FIG. 2(b).

FIG. 2(a) is a plane view illustrating the illumination device 20 according to one embodiment of the present invention. Further, FIG. 2(b) is a cross-sectional view taken along line B-B′ in FIG. 2(a).

Embodiment 2 is different from Embodiment 1 in shape of the fixing pin. Arrangements other than the fixing pin in

Embodiment 2 are the same as those in Embodiment 1, and therefore are not described here.

In the illumination device 20 in FIG. 2(b), a first partition wall 21, a second partition wall 22, a diffusion plate 23, an optical section 24, a reflecting plate 25, a light source 27 and a light source block 28 respectively correspond to the first partition wall 11, the second partition wall 12, the diffusion plate 13, the optical section 14, the reflecting plate 15, the light source 17 and the light source block 18 in the illumination device 10 in FIG. 1(b).

On top portions of first partition walls 21 are provided a plurality of holes at respective intersections of the first partition walls 21 that intersect each other substantially at right angle. The top portions of the first partition walls 21 have contact with the diffusion plate 23. In the diffusion plate 23, through holes are provided at positions each corresponding to each of the plurality of holes provided on the top portions of the first partition walls 21. A fixing pin 26 is inserted into each of the plurality of holes on the first partition walls 21 and its corresponding hole on the diffusion plate 23 (hereinafter, a portion of the fixing pin which portion is inserted into the hole of the first partition wall and the corresponding hole of the diffusion plate is referred to as an insertion portion of the fixing pin). In this way, the diffusion plate 23 is fixed to the first partition walls 21.

The fixing pin 26 includes a support section 26a for supporting the optical section 24. Accordingly, the fixing pins 26 can support the optical section 24. In other words, the fixing pin 26 is configured to have a length necessary for the fixing pin 26 to support the optical section 24 when the fixing pin 26 is inserted into the hole provided in the first partition wall 21 and the corresponding hole of the diffusion plate 23. This maintains a distance between the diffusion plate 23 and the optical section 24 to be constant.

As a material of the fixing pins 26, white PC having good light reflectance is preferable. However, the material of the fixing pins 26 is not limited particularly, as long as the fixing pins 26 can fix the first partition walls 21 to the diffusion plate 23 provided on the first partition walls 21 so as to maintain a distance between the diffusion plate 23 and the optical section 24 to be constant. That is, the material of the fixing pins 26 is not limited to the white PC, and a transparent material can be used, for example.

In the present embodiment, the hole into which the fixing pin 26 is inserted is provided, more specifically, in a column shape on a surface of the top portion of the first partition wall 21 which surface has contact with the diffusion plate 23. Similarly, a portion of the diffusion plate 23 that corresponds to the hole provided on the top portion of the first partition wall 21 is processed so that a circular hole is formed. Then, the fixing pin 26 is inserted into the hole on the top portion of the first partition wall 21 and the corresponding hole in the diffusion plate 23. As such, a plurality of holes are provided on the top portions of the first partition walls 21, and a plurality of holes are provided on the diffusion plate 23 in a corresponding manner. The fixing pins 26 are then inserted into a respective of the plurality of holes on the top portions of the first partition walls 21 and a respective of the plurality of holes on the diffusion plate 23 in a corresponding manner, thereby fixing the diffusion plate 23 to the first partition walls 21.

In the present embodiment, the fixing pin 26 is arranged such that a portion other than the insertion portion in the fixing pin 26 has a length of 15 mm. This is because the distance between the diffusion plate 23 and the optical section 24 is 15 mm. A shape of the portion other than the insertion portion of the fixing pin 26 is not limited to a particular shape provided that the distance between the diffusion plate 23 and the optical section 34 can be kept constant. In the present embodiment, the portion other than the insertion portion is constituted by a column-shaped part and a cone-shaped part in combination. Further, the portion other than the insertion portion in the fixing pin 26 may be shorter than the distance between the diffusion plate 23 and the optical section 24. However, if the portion other than the insertion portion is too short, the optical section 24 may be warped.

Similarly to the fixing pins 16 in Embodiment 1, with the use of the fixing pins 26 according to the present embodiment, it is possible to prevent the diffusion plate 23 from bending or warping. In addition, it is possible to prevent the optical section 24 from bending or warping.

That is, with the arrangement in which the fixing pins 26 maintains the spatial distance between the diffusion plate 23 and the optical section 24 to be constant, it is possible to prevent the optical section 24 from warping. As a result, in a case where a certain light source block 28 is turned on, it is possible to prevent such a problem that a luminance distribution (spread of luminance) becomes different depending on where the light source block 28 that is turned on is located.

As described above, according to the illumination device 20, it is possible to provide a high-quality illumination device that can irradiate light having a more constant luminance distribution regardless of which light source block 28 is turned on, in a case where a certain light source block 28 is turned on.

### Embodiment 3

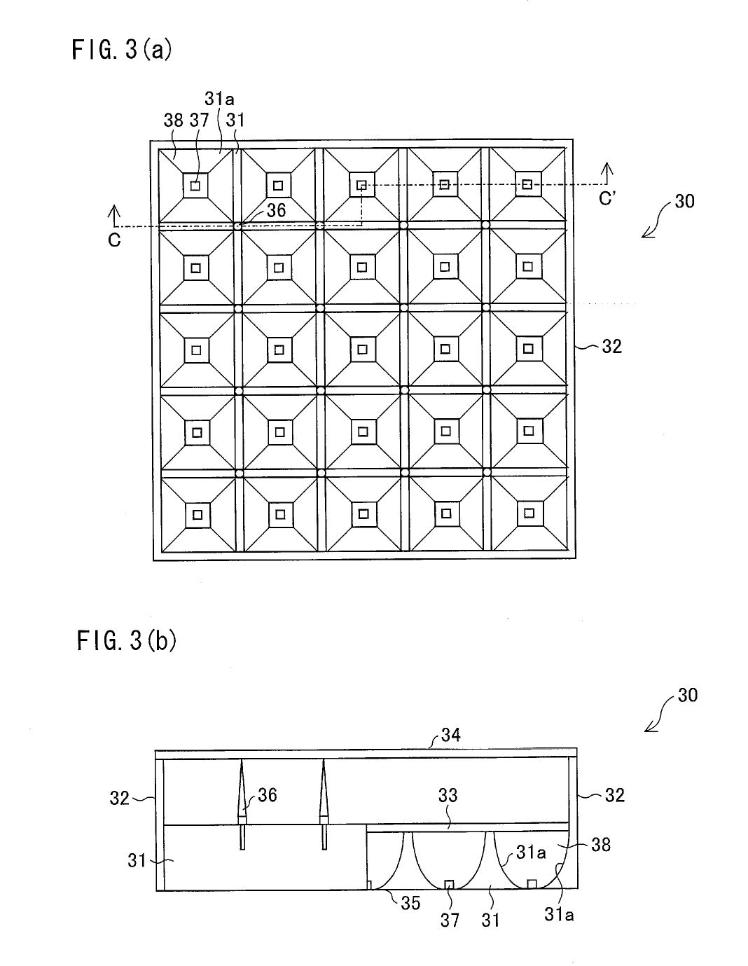

Next will be explained about an illumination device 30 according to the present embodiment with reference to FIG. 3(a) and FIG. 3(b).

FIG. 3(a) is a plane view illustrating the illumination device 30 according to one embodiment of the present invention. FIG. 3(b) is a cross-sectional view taken along line C-C′ in FIG. 3(a).

Embodiment 3 is different from Embodiment 2 in shape of a side surface of the first partition wall. Other arrangements are the same as those in Embodiment 2 and therefore are not explained here.

In the illumination device 30 in FIG. 3(b), a second partition wall 32, a diffusion plate 33, an optical section 34, a reflecting plate 35, a fixing pin 36, a light source 37 and a light source block 38 respectively correspond to the second partition wall 22, the diffusion plate 23, the optical section 24, the reflecting plate 25, the fixing pin 26, the light source 27 and the light source block 28 in FIG. 2(b).

A side surface 31a of the first partition wall 31 has a recessed curved-surface shape from a top surface of the first partition wall 31 toward a bottom surface of the first partition wall 31. The top surface is a contact surface of the first partition wall 31 which surface has contact with the diffusion plate 33, and the bottom surface is a contact surface of the first partition wall 31 which surface has contact with the reflecting plate 35.

When (i) a surface of the first partition wall 31 that has contact with the diffusion plate 33 is taken as a top surface, (ii) a surface of the first partition wall 31 that has contact with a plane on which the light source 27 is provided is taken as a bottom surface, and (iii) a direction that defines a thickness of the first partition wall 31 is taken as a width direction, a length, in a width direction, of the bottom surface is longer than that of the top surface (in other words, a width of the bottom surface is wider than a width of the top surface, or an area of the bottom surface is larger than that of the top surface), and the side surface 31a with respect to the top surface is formed at least partially in a recessed curved-surface shape.

The light source block 38 is enclosed by four first partition walls 31 each including such a side surface 31a having a recessed curved-surface shape. Further, it is preferable that a side surface 31a that serves as at least a part of a surface of the second partition wall 32 which surface faces the first partition wall 31, also have a recessed curved-surface shape so as to form a pair with the curved-surface shape of the first partition wall 31 that the surface of the second partition wall 32 faces. That is, when (i) a region in the second partition wall 32 that makes contact with the diffusion plate 33 is taken as a contact region, (ii) a surface of the second partition wall 32 that makes contact with a plane on which the light source 37 is provided is taken as a bottom surface, and (iii) a direction that defines a thickness of the second partition wall 32 is taken as a width direction, it is preferable that a length, in a width direction, of the bottom surface be longer than a length, in a width direction, of the contact surface of the second partition wall 32.

In a case where the side surface of the first partition wall, which is a sidewall of the light source block, is provided in a planar shape, and the side surface is disposed substantially at right angle to the reflecting plate, which is a bottom surface of the light source block, there may occur such a problem that luminance is decreased in comparison with a case where no first partition wall is provided. One of the reasons is that light emitted from a light source in each of the light source blocks separated from each other by the first partition walls is looped and absorbed within the each of the light source blocks. As a result, it is considered that the light emitted from the light source cannot be outputted efficiently from the each of the light source blocks.

In view of this, in the illumination device 30 according to the present embodiment, the side surfaces 31a of the first partition wall 31 and the second partition wall 32 have the recessed curved-surface shape as described above.

As a result, each of the side surfaces 31a can efficiently reflect light emitted from the light source 37 upward. Accordingly, with the arrangement in which the first partition walls are provided as such, it is possible to restrain the decrease in luminance as compared to the case where no first partition wall is provided.

Further, by forming a surface of the second partition wall 32 that faces the first partition wall 31 in the same manner as the side surface 31a of the first partition wall 31, it is possible to efficiently reflect light emitted from the light source 27 toward a direction of the diffusion plate 33, even in a light source block 38 that is partially enclosed by the second partition wall 32.

In this way, according to the illumination device 30 of the present embodiment, it is possible to provide an illumination deice which has the same effect as in the illumination device 20 of Embodiment 2 and further witch can emit light efficiently.

### Modified Example 1

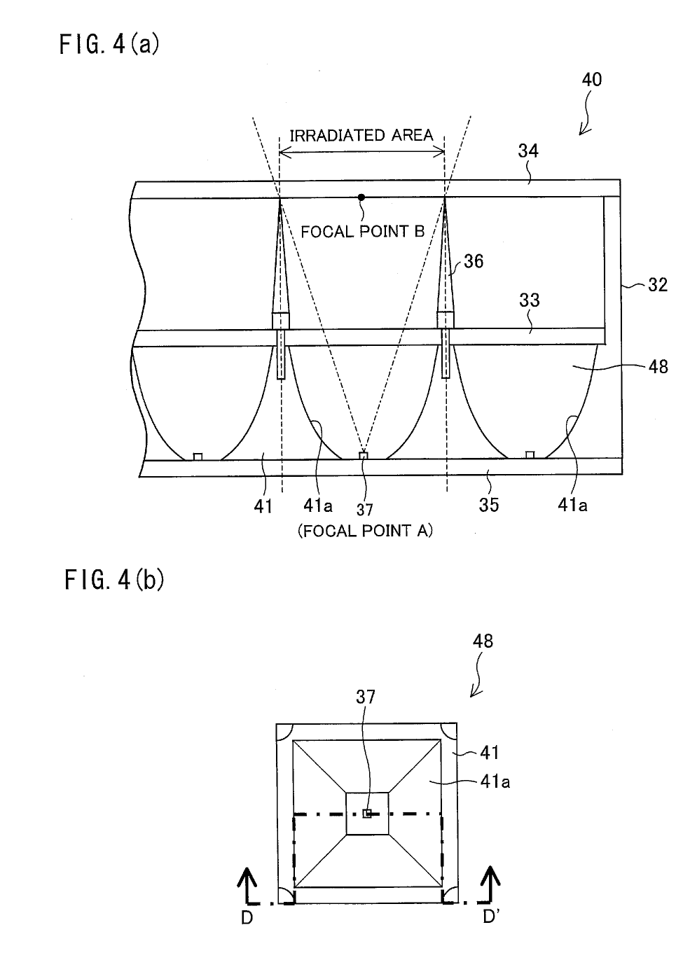

The first partition wall 31 in the illumination device 30 according to Embodiment 3 may be arranged as illustrated in FIG. 4(a) and FIG. 4(b).

FIG. 4(a) is a cross-sectional view schematically illustrating an arrangement of an illumination device 40 as a modified example according to the present embodiment. FIG. 4(b) is a view illustrating an arrangement of a light source block 48 in the illumination device 40 in FIG. 4(a). FIG. 4(b) is a plane view illustrating the arrangement of the light source block 48 in the illumination device 40 in FIG. 4(a). FIG. 4(a) is a cross section viewed along allows D-D′ in FIG. 4(b).

The illumination device 40 is different from the illumination device 30 in curved-surface shape of the sidewall of the first partition wall. Other arrangements are the same as those in the illumination device 30 and therefore are not described here. The same members as those in the above embodiment have the same reference signs as above, and the explanation about these members is omitted.

A side surface 41a of each first partition wall 41 enclosing the light source block 48 has a recessed curved-surface shape from a top surface of the first partition wall 41 toward a bottom surface of the first partition wall 41. The top surface is a contact surface of the first partition wall which has contact with the diffusion plate 33, and the bottom surface is a contact surface of the first partition wall 41 which has contact with the reflecting plate 35. Further, it is preferable that a side surface 41a that is at least a part of a surface of the second partition wall 32 which surface faces the first partition wall 41 also have a recessed curved-surface shape so as to form a pair with the curved-surface shape of the first partition wall 41 that the surface of the second partition wall 32 faces. That is, when (i) a region, in the second partition wall 32, that makes contact with the diffusion plate 33 is taken as a contact region, (ii) a surface, of the second partition wall 32, that makes contact with a plane on which the light source 37 is provided is taken as a bottom surface, and (iii) a direction that defines a thickness of the second partition wall 32 is taken as a width direction, it is preferable that a length of a width direction of the bottom surface be longer than a length, in a width direction, of the contact surface of the second partition wall 32.

In a cross section in a plane vertical to an extending direction of each of the first partition wall 41 and the second partition wall 32, the recessed curved-surface shape of the side surface 41a of each of the first partition wall 41 and the second partition wall 32 is formed so as to draw a part of an elliptical shape.

Further, the light source 37 is positioned at a center (referred to as a bottom center) of the plane, in the light source block 48, on which the light source 37 is provided. The position where the light source 37 is provided is referred to as a focal point A. In the meantime, on a surface of the optical section 34 which surface faces the light source 37, a position corresponding to the light source 37 is referred to as a focal point B. The side surface 41a forms a curved-surface shape partially cut out of an ellipse formed around the focal point B so as to pass the focal point A.

In a case where the plane, in the light source block, on which the light source is provided is substantially vertical to partition walls enclosing the light source block, there may occur such a problem that a part of light emitted from the light source does not reach an upper side of the light source block and is looped within the light source block.

In contrast, in a case where the side surface 41a is provided in such a curved-surface shape partially cut out of the ellipse as described above, light emitted from the light source 37 reflects off the side surface 41a, thereby resulting in that the reflecting light can be efficiently irradiated toward the upper side of the light source block 48.

As such, with the arrangement of the illumination device 40, it is possible to provide an illumination device which has the same effect as that of the illumination device 30, which can efficiently emit light upward toward the diffusion plate 33, and which hardly decreases luminance as compared with a case where the first partition walls and the second partition walls are provided vertically to a bottom surface of the light source block.

The above elliptical shape is just an example, and the shape of the side surfaces 41a of the first partition wall 41 and the second partition wall 32 is not limited to this as long as the side surfaces 41a are provided such that their cross sections in a vertical direction to a long-axial direction form a part of an ellipse. Further, the focal points A and B may be positioned at different positions from the above. In addition, it is preferable that a long axis or a short axis of the ellipse formed around the focal point B so as to pass the focal point A be adjusted as appropriate so that the aforementioned effect can be obtained.

### Modified Example 2

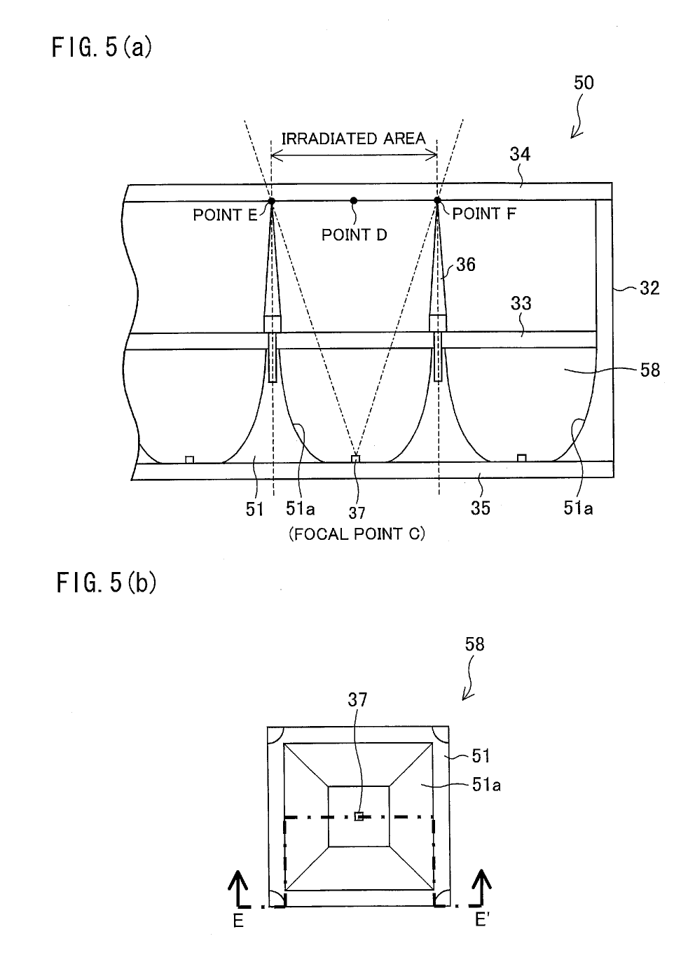

The first partition wall 41 in the illumination device 40 in Modified Example 1 may be arranged as illustrated in FIG. 5(a) and FIG. 5(b).

FIG. 5(a) is a cross-sectional view schematically illustrating an arrangement of an illumination device 50 in a second modified example according to the present embodiment. FIG. 5(b) is a plane view illustrating an arrangement of a light source block 58 in the illumination device 50 in FIG. 5(a). FIG. 5(a) is a cross section viewed along allows E-E′ in FIG. 5(b).

The illumination device 50 is different from the illumination device 40 in curved-surface shape of the sidewall of the first partition wall. Other arrangements are the same as those in the illumination device 40 and therefore are not described here. The same members as those in the above embodiment have the same reference signs as above, and the explanation about these members is omitted.

A side surface 51a of each first partition wall 51 enclosing the light source block 58 has a recessed curved-surface shape from a top surface of the first partition wall 51 toward a bottom surface of the first partition wall 51. The top surface is a contact surface of the first partition wall that has contact with the diffusion plate 33, and the bottom surface is a contact surface of the first partition wall that has contact with the reflecting plate 35. Further, it is preferable that at least a part of a surface of the second partition wall 32 which surface faces the first partition wall 51 also have a recessed curved-surface shape so as to form a pair with the curved-surface shape of the first partition wall 51 that the surface of the second partition wall 32 faces. That is, when (i) a region, in the second partition wall 32, that makes contact with the diffusion plate 33 is taken as a contact region, (ii) a surface, of the second partition wall 32, that makes contact with a plane on which the light source 37 is provided is taken as a bottom surface, and (iii) a direction that defines a thickness of the second partition wall 32 is taken as a width direction, it is preferable that a length of a width direction of the bottom surface be longer than a length, in a width direction, of the contact surface of the second partition wall 32.

In a cross section in a plane vertical to an extending direction of each of the first partition wall 51 and the second partition wall 32, the recessed curved-surface shape of the side surface 51a of each of the first partition wall 51 and the second partition wall 32 is formed so as to be a part of a parabola.

Further, the light source 37 is positioned at a bottom center of the light source block 58. The position where the light source 37 is provided is referred to as a focal point C.

In the meantime, on a surface of the optical section 34 which surface faces a plane on which the light source 37 is provided, a position corresponding to the light source 37 is referred to as a position D. Points E and F are positioned at respective positions on the surface of the optical section 34 which respective positions are intersections of (i) a straight line on the surface of the optical section 34 which straight line passes the position D and (ii) respective lines on a periphery of the light source block 58 which respective lines extend vertically to the optical section 34. The side surface 51a forms a curved-surface shape partially cut out of a parabola that passes the points E and F and is constituted by the focal point C.

In such an arrangement, when light emitted from the light source 37 reaches the side surface 51a, the light reflects off the side surface 51a toward a substantially vertical direction to the plane on which the light source 37 is provided.

That is, with the arrangement in which the curve-surface shape of the side surface 51a forms a part of the parabola as described above, the light emitted from the light source 37 can be more efficiently irradiated toward an upper side direction (front direction) of the light source block 58, as compared with a case where the side surface has a partially-elliptical shape. As a result, it is possible to prevent a decrease in luminance.

Consequently, with the arrangement of the illumination device 50, it is possible to more efficiently emit light upward toward the diffusion plate 33, as compared with the illumination device 40. Accordingly, it is possible to provide an illumination device that hardly decreases luminance as compared with a case where the first partition walls are provided vertically to a bottom surface of the light source block.

The above parabola is just an example, and the shape of the side surfaces 51a of the first partition wall 51 and the second partition wall 32 is not limited to this as long as the side surfaces 51a are provided such that their cross sections in a vertical direction to a long-axial direction form a part of a parabola. Further, the focal point C may be positioned at a different position from the above. In addition, respective points that the parabola passes on the optical section 34 may be provided at different positions from the points E and F.

### Modified Example 3

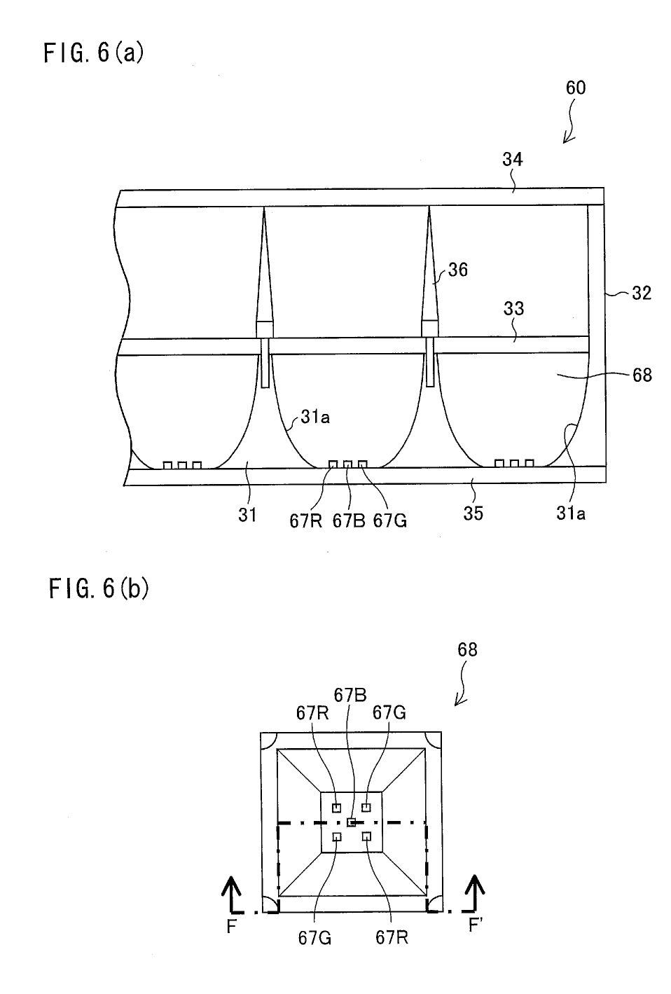

The illumination device 30 in Embodiment 3 may be arranged as illustrated in FIG. 6(a) and FIG. 6(b).

FIG. 6(a) is a cross-sectional view schematically illustrating an arrangement of an illumination device 60 in a third modified example according to the present embodiment. FIG. 6(b) is a plane view illustrating an arrangement of a light source block 68 in the illumination device 60 in FIG. 6(a). FIG. 6(a) is a cross section viewed along allows F-F′ in FIG. 6(b).

The illumination device 60 is different from the illumination device 30 in that a plurality of LEDs having different wavelengths are used as a light source. Other arrangements are the same as those in the illumination device 30 and therefore are not described here. The same members as those in the above embodiment have the same reference signs as above, and the explanation about these members is omitted.

The illumination device 60 is provided with three types of elements, a red LED 67R, a green LED 67G, and a blue LED 67B, which are LEDs having different wavelengths. These LEDs are provided on a reflecting plate 35. More specifically, in the illumination device 60 is provided two red LEDs 67R, two green LEDs 67G, and one blue LED 67B. The blue LED 67B is provided at a center. The two red LEDs 67R are provided symmetrically with respect to the blue LED 67B while the two green LEDs 67G are provided symmetrically with respect to the blue LED 67B.

The respective numbers and positions of the red LED 67R, the green LED 67G, and the blue LED 67B are not limited to those in the present modified example, and can be altered as appropriate.

With the use of the plurality of LED elements having different wavelengths as a light source as illustrated in the present modified example, it is possible to provide a high-quality illumination device having a wide color-reproduction range. Moreover, each of the red LED 67R, the green LED 67G, and the blue LED 67B can be applied to the light sources 17 and 27 respectively illustrated in Embodiments 1 and 2. In this case, the illumination devices 10 and 20 can be high-quality illumination devices which have the respective effects described in Embodiments 1 and 2 and which also have a wide color-reproduction range.

### Modified Example 4

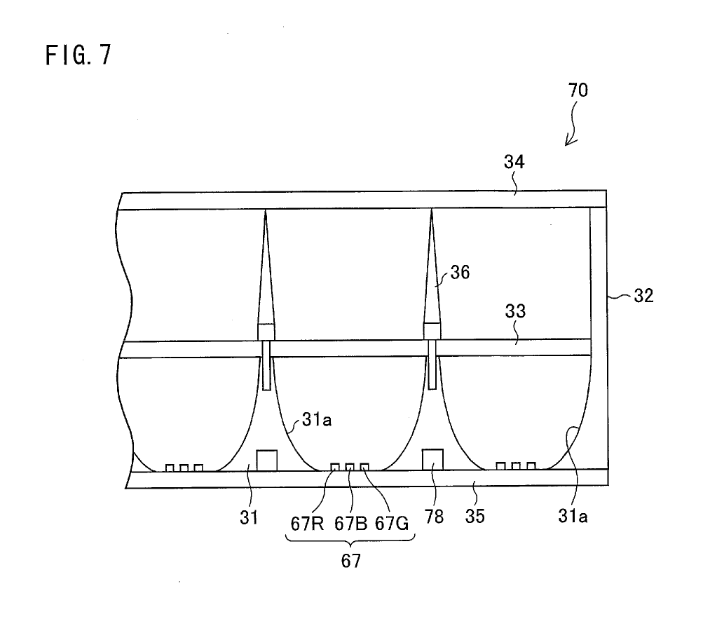

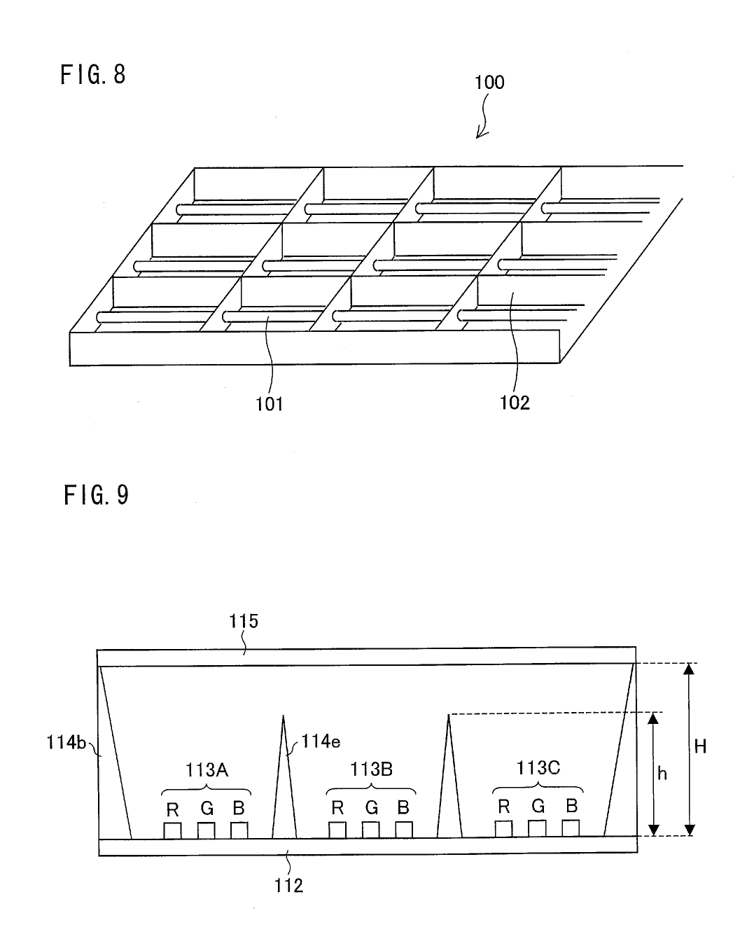

The illumination device 60 in Modified Example 3 may be arranged as illustrated in FIG. 7.

FIG. 7 is a cross-sectional view schematically illustrating an arrangement of an illumination device 70 as a fourth modified example according to the present embodiment.

The illumination device 70 is different from the illumination device 60 in that a driver for driving an LED is provided on the same side where the LED is provided. Other arrangements are the same as those in the illumination device 60, and therefore are not described here. The same members as those in the above embodiment have the same reference signs, and the explanation about the members is omitted.

In a case where a driver for driving an LED 67 is provided on a backside of a reflecting plate 35 (i.e., on a side of the reflecting plate 35 on which side the LED 67 is not provided), there may occur such a problem that a space, on the backside, where a member (for example, a heat-releasing rubber) for releasing heat is disposed is reduced.

In contrast, in a case of the present modified example, a side surface 31a of a first partition wall 31 has a recessed curved-surface shape, and therefore a surface of the first partition wall 31 which surface has contact with a reflecting plate has a larger area than a top portion of the first partition wall 31. On this account, it is possible to provide a driver 78 for driving the LED 67 inside the first partition wall 31.

As a result, it is possible to make the backside of the reflecting plate 35 planar as compared to a case where the driver 78 is provide on the backside of the reflecting plate 35. This allows for making a space on the backside of the reflecting plate 35 on which to dispose a heat-releasing rubber or the like, thereby resulting in that it is possible to provide an illumination device having a high heat-releasing property.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

In a case where a plurality of light-emitting regions are provided and luminance is adjusted per light-emitting region, luminance unevenness and color unevenness are caused between the plurality of light-emitting regions. The present invention can restrain such luminance unevenness and color unevenness and thereby can make a luminance distribution uniform. Consequently, the present invention can be widely applied to various electric devices equipped with a surface light source and required to have a wide dynamic range for controlling light intensity of the surface light source.

1. An illumination device capable of adjusting luminance per light-emitting region, comprising:
first partition walls by which a plurality of light-emitting regions are separated;
light sources each for emitting light having different wavelengths, the light sources being provided in a respective of the plurality of light-emitting regions;
second partition walls which are provided higher than the first partition walls and which enclose the plurality of light-emitting regions;
optical means for diffusing the light emitted from each of the light sources, the optical means being supported by the second partition walls; and
a diffusion section for diffusing the light emitted from the each of the light sources, the diffusion section being fixed on the first partition walls so as to be disposed on upper sides of the plurality of light-emitting regions.

2. The illumination device as set forth in claim 1, further comprising:
fixing members for fixing the diffusion section to the first partition walls,
each of the fixing members including a support section for supporting the optical means.

3. The illumination device as set forth in claim 1, wherein:
each of the first partition walls has a bottom surface whose length in a width direction is longer than that of a top surface of the each of the first partition walls, where (i) the top surface is a surface, of the each of the first partition walls, that has contact with the diffusion section, (ii) the bottom surface is another surface, of the each of the first partition walls, that has contact with a plane on which the light sources are provided, and (iii) the width direction is a direction that defines a thickness of the each of the first partition walls, and
the each of the first partition walls has a side surface with respect to the top surface which side surface is formed at least partially in a recessed curved-surface shape.

4. The illumination device as set forth in claim 3, wherein:
the recessed curved-surface shape is formed such that a part of the side surface of the each of the first side walls draws a part of an ellipse, in a cross-sectional plane of the each of the first side walls which plane cuts across along a direction vertical to an extending direction of the each of the first partition walls.

5. The illumination device as set forth in claim 3, wherein:
the recessed curved-surface shape is formed such that a part of the side surface of the each of the first side walls draws a part of a parabola, in a cross-sectional plane of the each of the first side walls which plane cuts across along a direction vertical to an extending direction of the each of the first partition walls.

6. The illumination device as set forth in claim 3, wherein:
each of the second partition walls has a surface which faces a corresponding first partition wall and which at least partially has a recessed curved-surface shape so as to form a pair with a curved-surface shape of the corresponding first partition wall.

7. The illumination device as set forth in claim 1, wherein:
each of the light sources is an LED element.

8. The illumination device as set forth in claim 3, wherein a circuit component for driving a corresponding light source is provided inside a corresponding first partition wall.

9. A liquid crystal display device comprising:
an illumination device as set forth in claim 1; and
a liquid crystal panel.
